(19) United States
(12) Patent Application Publication
(10) Pub. No.: US 2001/0010804 A1
(43) Pub. Date: Aug. 2, 2001

(54) Apparatus for purifying exhaust gas of internal combustion engine

(76) Inventor: Yoshihiro Majima, Inuyama-city (JP)

Correspondence Address: Larry S. Nixon, Esq., NIXON & VANDERHYE P.C., 8th Floor, 1100 North Glebe Rd., Arlington, VA, 22201-4714, US

(21) Appl. No.: 09/738,842

(22) Filed: Dec. 18, 2000

(30) Foreign Application Priority Data
Dec. 17, 1999 (JP) 11-358328

(51) Int. Cl. B01D 53/34; B01D 53/88; B01D 53/94; F01N 3/28

(52) U.S. Cl. 422/180; 422/171; 422/177

(57) ABSTRACT

In an apparatus for purifying exhaust gas of an engine, both upstream and downstream catalysts are disposed in an exhaust pipe in series. The upstream catalyst is divided into upstream and downstream catalyst blocks to form a space portion therebetween, so that an exhaust pulsation generated by an exhaust manifold is transmitted to the space portion. By the exhaust pulsation, exhaust gas in the space portion flows repeatedly into a downstream part of the upstream catalyst block and an upstream part of the downstream catalyst block. Therefore, when an amount of a precious metal carried by at least one of the downstream part of the upstream catalyst block and the upstream part of the downstream catalyst block is increased, exhaust gas can be effectively purified. Accordingly, a purifying ratio of exhaust gas can be increased effectively using the exhaust pulsation.

### CROSS-REFERENCE TO RELATED APPLICATION

This application is related to and claims priority from Japanese Patent Application No. Hei. 11-358328 filed on Dec. 17, 1999, the contents of which are hereby incorporated by reference.

### BACKGROUND OF THE INVENTION

1. Field of the Invention

The present invention relates to an apparatus for purifying an exhaust gas of an internal combustion engine by using a catalyst.

2. Description of the Related Art

For purification of an exhaust gas from an ordinarily-employed gasoline engine vehicle, it is the common practice to dispose a catalyst such as three way catalyst in an exhaust pipe to oxidize or reduce HC (hydrogen carbide), CO (carbon monoxide) or NOx (nitrogen oxides) in the exhaust gas by the catalytic action of a precious metal carried on the catalyst.

Exhaust gas purifying action of the catalyst is accelerated when it is brought into contact with a precious metal carried on the catalyst. Accordingly, the longer the contact time of the exhaust gas with the catalyst, the higher the purification ratio of the exhaust gas. As means for extending the contact time of the exhaust gas with the catalyst, a catalyst capacity has conventionally been increased. However, when the catalyst capacity is increased, an exhaust resistance (pressure loss) becomes larger so that an engine output is decreased, and moreover, a warming (activation) of the catalyst after starting becomes delay so that an exhaust emission at starting is deteriorated.

### SUMMARY OF THE INVENTION

In view of the foregoing problems, it is an object of the present invention to provide an apparatus for purifying an exhaust gas of an internal combustion engine by using a catalyst, which improves a purification ratio of the exhaust gas without increasing a catalyst capacity.

According to the present invention, in an apparatus for purifying exhaust gas from an internal combustion engine, a catalyst is divided into an upstream catalyst block disposed at an upstream side, and a downstream catalyst block disposed at a downstream side of the upstream catalyst block to form a space therebetween. Further, a precious metal is carried in the upstream catalyst block and the downstream catalyst block in such a manner that an amount of the precious metal carried by at least one of a downstream portion of the upstream catalyst block and an upstream portion of the downstream catalyst block is made larger than that carried by the other part of the upstream catalyst block and the downstream catalyst block. Because the catalyst is divided into the upstream and downstream catalyst blocks, a pressure loss in the upstream catalyst block becomes smaller, and an exhaust pulsation generated by an exhaust manifold can be transmitted to the space between the upstream and downstream catalyst blocks. In a place where the exhaust pulsation is generated, exhaust gas flows repeatedly forward and backward. Therefore, when the exhaust pulsation is generated in the space between upstream and downstream catalyst blocks, exhaust gas repeatedly flows into the downstream portion of the upstream catalyst block and the upstream portion of the downstream catalyst block portion. Accordingly, when the amount of the precious metal carried by at least one of the downstream portion of the upstream catalyst block and the upstream portion of the downstream catalyst block is made larger than that carried by the other part of the upstream catalyst block and the downstream catalyst block, exhaust gas can be effectively purified. Because a purification ratio of the exhaust gas is increased, a catalyst capacity can be reduced.

Preferably, palladium (Pd) is carried in the upstream catalyst block and the downstream catalyst block in such a manner that an amount of palladium carried by at least one of the downstream portion of the upstream catalyst block and the upstream portion of the downstream catalyst block is made larger than that carried by the other part of the upstream catalyst block and the downstream catalyst block. The activation temperature of Pd is lower than that of the other precious metal such as Pt or Ph. Accordingly, in the downstream portion of the upstream catalyst block and/or the upstream portion of the downstream catalyst block, due to synergism of the early activation of Pd carried on the block and exhaust pulsation, an improvement in exhaust emission at an engine starting time is obtained.

Further, control means, for performing a catalyst early warming control in which the catalyst is early activated at a starting period of the engine, is provided. The catalyst is disposed at a predetermined position which is set based on heat quantity discharged from the engine during the catalyst early warming control, and a surface area of an exhaust pipe extending from the engine to the catalyst. Therefore, the catalyst can be disposed at a suitable position while it can prevent the thermal deterioration of an upstream catalyst part or engine power down due to an increase in the pressure loss.

### BRIEF DESCRIPTION OF THE DRAWINGS

Additional objects and advantages of the present invention will be more readily apparent from the following detailed description of preferred embodiments when taken together with the accompanying drawings, in which:

FIG. 1 is a schematic diagram of an exhaust gas control system of an engine according to a first preferred embodiment of the present invention;

FIGS. 2A, 2B, 2C are vertical sectional views of an upstream catalyst, showing distribution examples of a precious metal amount carried on the upstream catalyst, according to the first embodiment;

FIG. 3 is a view showing examples of a capacity of an all upstream catalyst, a capacity of an upstream catalyst block of the upstream catalyst and a capacity of a downstream catalyst block of the upstream catalyst, set in accordance with a displacement of an engine, according to the first embodiment;

FIG. 4 is a view showing examples of a predetermined valve A set in accordance with the capacity of the upstream catalyst, according to the first embodiment;

FIG. 5 is a vertical sectional view of an upstream catalyst according to a second preferred embodiment of the present invention;

FIG. 6 is a vertical sectional view of an upstream catalyst according to a third preferred embodiment of the present invention;

FIG. 7 is a vertical sectional view of an upstream catalyst according to a fourth preferred embodiment of the present invention;

FIG. 8 is a vertical sectional view of an upstream catalyst according to a fifth preferred embodiment of the present invention;

FIGS. 9A and 9B are vertical sectional views of upstream catalysts, each showing a secondary air introducing method, according to a sixth preferred embodiment of the present invention;

FIG. 10 is a vertical sectional view of an upstream catalyst according to a seventh preferred embodiment of the present invention; and

FIG. 11 is a vertical sectional view of an upstream catalyst according to an eighth preferred embodiment of the present invention.

### DETAILED DESCRIPTION OF THE PREFERRED EMBODIMENTS

Preferred embodiments of the present invention will be described hereinafter with reference to the accompanying drawings.

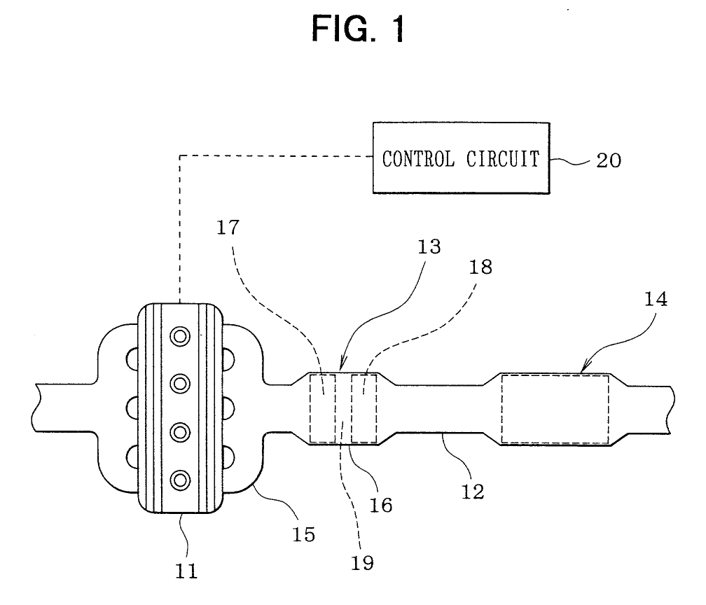

A first preferred embodiment of the present invention will hereinafter be described based on FIGS. 1 to 4. As illustrated in FIG. 1, two upstream and downstream catalysts 13, 14 are disposed in series in an exhaust pipe 12 (i.e., an exhaust gas passage) of an engine 11. The upstream catalyst 13 is formed to have a relatively small capacity as will be described later in order to early activate after starting, and is disposed in the vicinity of an exhaust manifold 15. on the other hand, the downstream catalyst 14 is formed to have a relatively large capacity as will be described later, and is disposed at a lower side of a bottom surface of a vehicle frame. Each of the catalysts 13, 14 is formed to have a precious metal such as Pd, Pt or Ph carried on the inner wall surface of a honeycomb ceramic carrier. Each of the catalysts 13, 14 does not necessarily carry thereon all three precious metals, that is, Pd, Pt and Ph. It can carry thereon two or one of them, or precious metals of the catalyst are not limited to Pd, Pt and Ph.

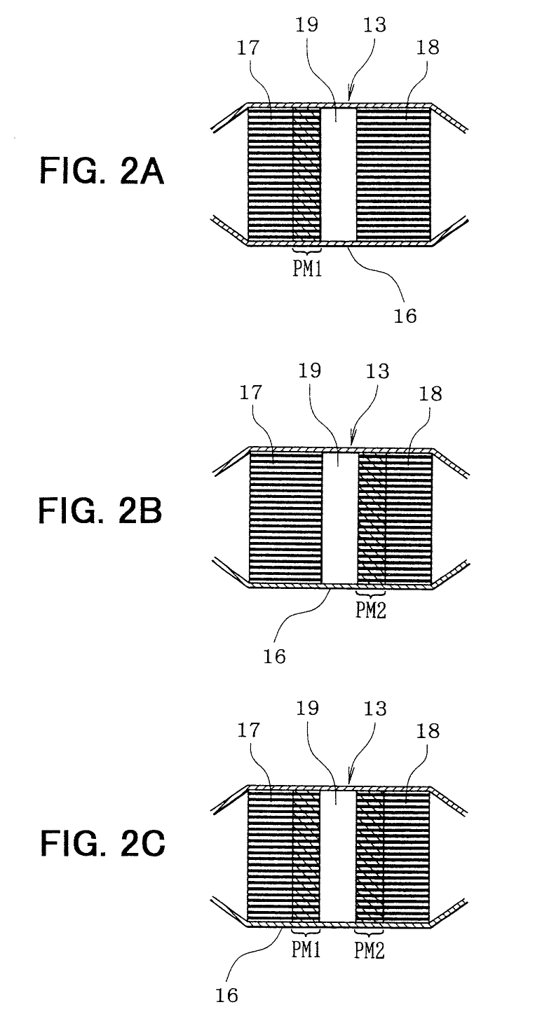

As illustrated in FIGS. 2A-2C, the upstream catalyst 13 is disposed inside a single catalyst case 16, while being divided into an upstream catalyst block 17 and a downstream catalyst block 18. Between the upstream and downstream catalyst blocks 17, 18, a space portion 19 is provided in the catalyst case 16. For efficient purification of the exhaust gas by effective using exhaust pulsation generated in the space portion 9, the distribution of an amount of the precious metal held on the catalyst blocks 17, 18 is set as shown in FIGS. 2A, 2B and 2C, for example. When the distribution amount of the precious metal is set as illustrated in FIG. 2A, the amount of the precious metal carried by a downstream portion PM1 of the upstream catalyst block 17 is greater than that of the other portion. When the distribution amount of the precious metal is set as illustrated in FIG. 2B, the amount of the precious metal carried by an upstream portion PM2 of the downstream catalyst block 18 is greater than that of the other portion. When the distribution amount of the precious metal is set as illustrated in FIG. 2C, the amount of the precious metal carried by the downstream portion PM1 of the upstream catalyst block 17 and that by the upstream portion PM2 of the downstream catalyst block 18 are both greater than that of the other portion.

When the catalysts 13, 14 are not active rightly after starting, exhaust gas such as HC, CO and NOx exhausted from the engine 11 cannot be purified sufficiently. In an engine control circuit 20, temperature of the exhaust gas is increased by performing, just after starting, an ignition time lag control and a catalyst early warming control such as air/fuel ratio lean control, so that the upstream catalyst 13 is early heated and the time necessary for activation of the whole catalyst is shortened.

During the catalyst early warming control, after the upstream catalyst block 17 in the upstream catalyst 13 is activated, the downstream catalyst block 18 of the upstream catalyst 13 is activated. Thereafter, the downstream catalyst 14 is activated. The upstream catalyst 13 is for purifying an exhaust gas until the downstream catalyst 14 is activated. Therefore, activation of the upstream catalyst 13 must occur as early as possible. Accordingly, the capacity of the upstream catalyst 13 is therefore set smaller than that of the downstream catalyst 14. Further, the capacity of the upstream catalyst block 17 is set smaller than that of the downstream catalyst block 18 for effecting activation as early as possible. Moreover, the capacity of the upstream catalyst block 17 is set in consideration of exhaust pulsation to be generated in the space portion 19 at the downstream side of the upstream catalyst block 17. The exhaust pulsation cannot readily be generated in the space portion 19 on the downstream side of the upstream catalyst block 17, if a pressure loss of the upstream catalyst block 17 becomes excessively large.

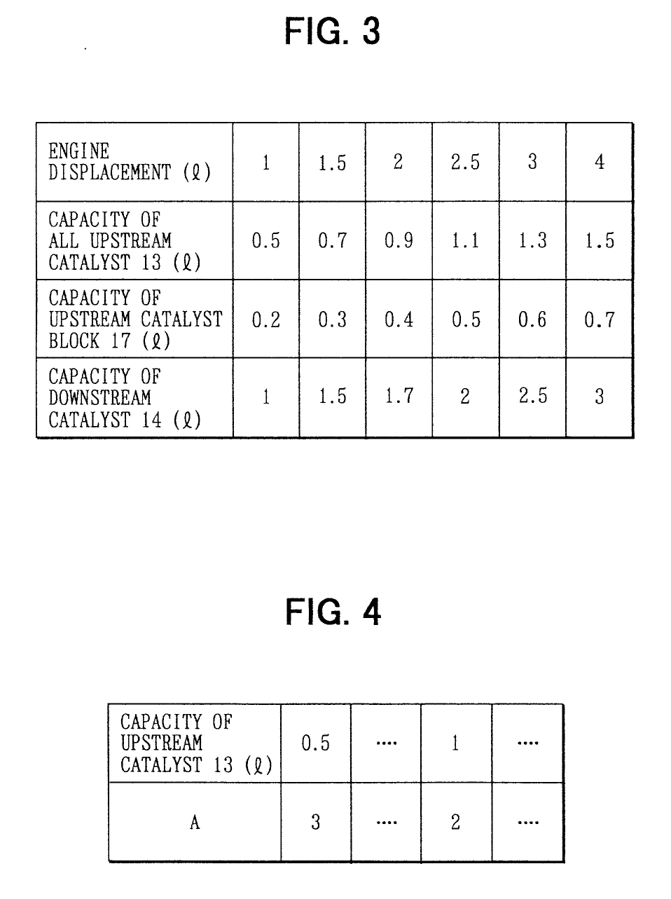

Since the heat quantity given by the exhaust gas to the catalysts 13, 14 or the amount of components to be purified from the exhaust gas differs with a displacement (i.e., exhaust amount) of the engine, the capacity of all the upstream catalyst 13, the capacity of the upstream catalyst block 17 and the capacity of the downstream catalyst 14 are set based on the displacement of the engine in accordance with the table, as shown in FIG. 3.

The upstream catalyst 13 is disposed at a position satisfying the following equation (1) in order to ensure a heat quantity necessary for early activation of the catalyst 13.

(surface area S of exhaust pipe/heat quantity Q exhausted from engine)<A (1)

In the above equation, the surface area S of an exhaust pipe is a surface area from an engine 11 to an upstream end surface on the upstream of the upstream catalyst 13. Alternatively, the surface area S may be a surface area of an exhaust pipe per single cylinder or may be changed as needed according to the constitution of an exhaust gas system. The heat quantity Q of exhaust gas discharged from the engine 11 is calculated from an exhaust gas quantity per unit time (ex. 1 second) and temperature of the exhaust gas during catalyst early warming control.

The surface area S of the exhaust pipe is a parameter for evaluating a radiated heat of the heat quantity Q discharged from the engine 11, which is not supplied to the upstream catalyst 13 but released outside from the surface of the exhaust pipe. Therefore, the heat quantity supplied to the upstream catalyst 13 can be evaluated based on the surface area S of the exhaust pipe and heat quantity Q of exhaust gas discharged from engine 11. The above-described equation (1) utilizes to prescribe conditions necessary for ensuring a heat quantity required for early activation of the upstream catalyst 13.

The above-described equation (1) is satisfied when the upstream catalyst 13 is disposed too close to the engine 11. However, if the upstream catalyst 13 is disposed at a position proximate to the engine 11, inconveniences such as thermal deterioration of the upstream catalyst 13 or engine power down due to an increase in the pressure loss presumably occur. Accordingly, the upstream catalyst 13 is disposed at a position apart from the engine 11 within a range satisfying the above-described equation (1). Thus, it is possible to dispose the upstream catalyst 13 at an appropriate position permitting suppression of thermal deterioration of the upstream catalyst 13 or power down of the engine 11, while maintaining a heat quantity necessary for early activation of the upstream catalyst 13.

In the equation (1), the predetermined value A may be fixed, or may be changed, in accordance with the capacity of the upstream catalyst 13 based on the table as shown in FIG. 4. In this case, as the capacity of the upstream catalyst 13 becomes larger, the heat quantity necessary for early activation is increased. Therefore, in FIG. 4, the predetermined value A is decreased as the capacity of the upstream catalyst 13 becomes greater. Further, as the capacity of the upstream catalyst 13 becomes greater, the upstream catalyst 13 is disposed at more close to the engine 11, and the surface area S of the exhaust pipe is narrowed.

In the first embodiment, the upstream catalyst 13 is divided into the upstream catalyst block 17 and the downstream catalyst block 18, and the space portion 19 is formed between the upstream and downstream catalyst block 17, 18 to convey the exhaust pulsation generated in the exhaust manifold 15 to the space portion 19 between the upstream and downstream catalyst blocks 17, 18. In general, the exhaust pulsation cannot conveyed to the downstream side of the catalyst when the pressure loss in the catalyst is large. However, in the first embodiment, because the upstream catalyst 13 is divided into both the upstream and downstream catalyst blocks 17, 18, the pressure loss of the upstream catalyst block 17 can be decreased, whereby the exhaust pulsation can be conveyed to the space portion 19 which is a part of the upstream catalyst 13.

At the place where exhaust pulsation generates, exhaust gas flows downwardly while repeating forward flow and back flow by the exhaust pulsation. When exhaust pulsation occurs in the space portion 19 between the catalyst blocks 17, 18 of the upstream catalyst 13, the exhaust gas in the space portion 19 flows in repetition to the downstream portion PM1 of the upstream catalyst block 17 and the upstream portion PM2 of the downstream catalyst block 18, resulting in an increase in the frequency of the exhaust gas being brought into contact with the precious metal carried on the catalyst at the downstream portion PM1 of the upstream catalyst block 17 and the upstream portion PM2 of the downstream catalyst block 18, as compared with the other portion. Accordingly, as illustrated in FIGS. 2A-2C, when the amount of the precious metal carried on at least one of the downstream portion PM1 of the upstream catalyst block 17 and the upstream portion PM2 of the downstream catalyst block 18 is increased, it is possible to effectively purify the exhaust gas by effectively using exhaust pulsation occurring in the space portion 19 between the upstream and downstream catalyst blocks 17, 18 of the upstream catalyst 13. In addition, the amount of the precious metal held on the catalyst is increased only at the portion PM1, PM2 of the catalyst blocks 17, 18 on which exhaust pulsation exerts an influence. Therefore, a large cost rise can be avoided, as compared with a case where the amount of the precious metal is carried on the whole catalyst.

In the first embodiment, the amount of the precious metal (irrespective of its kind) carried on at least one of the downstream portion PM1 of the upstream catalyst block 17 and the upstream portion PM2 of the downstream catalyst block 18 is made greater than that of the other portion. For example, the amount of Pd carried on at least one of the downstream portion PM1 of the upstream catalyst block 17 and the upstream portion PM2 of the downstream catalyst block 18 may be made greater than that of the other portion. The activation temperature of Pd is lower than that of Pt or Ph. Therefore, when the amount of Pd carried on the downstream portion PM1 of the upstream catalyst block 17 and/or the upstream portion PM2 of the downstream catalyst block 18 are/is increased, it is possible to perform efficient purification of an exhaust gas in an early stage after the engine is started, at the downstream portion PM1 of the upstream catalyst block 17 and/or the upstream portion PM2 of the downstream catalyst block 18 due to synergism of the early activation of the precious metal (Pd) carried on the block and exhaust pulsation. Accordingly, an improvement in exhaust emission at starting is obtained.

It is also possible to set the amount of a precious metal carried on each of the catalyst blocks 17, 18 or an O₂ storage amount in each catalyst block 17, 18, depending on the engine displacement, because a substantial capacity of each of the catalyst blocks 17, 18 is determined by the amount of a precious metal or O₂ storage amount. Alternatively, at least one of the capacity, the amount of a precious metal, and the O₂ storage amount of each of the catalyst blocks 17, 18 may be determined depending on the heat quantity to be supplied or flow rate of the exhaust gas, because the heating temperature of each of the catalyst blocks 17, 18 or component amounts of an exhaust gas to be purified differs with the heat quantity to be supplied to each of the catalyst blocks 17, 18 or the flow rate of the exhaust gas. That is, the capacity of the upstream catalyst block 17 can be set based on at least one of the engine displacement, the heat quantity supplied to the upstream catalyst block 17 and a flow amount of exhaust gas in the upstream catalyst block 17.

The method for setting the capacity of the upstream catalyst 13 or the disposition of the catalyst described in the first embodiment will be suitably applied to a case where a upstream catalyst is not divided or only one catalyst is disposed in the exhaust pipe 12.

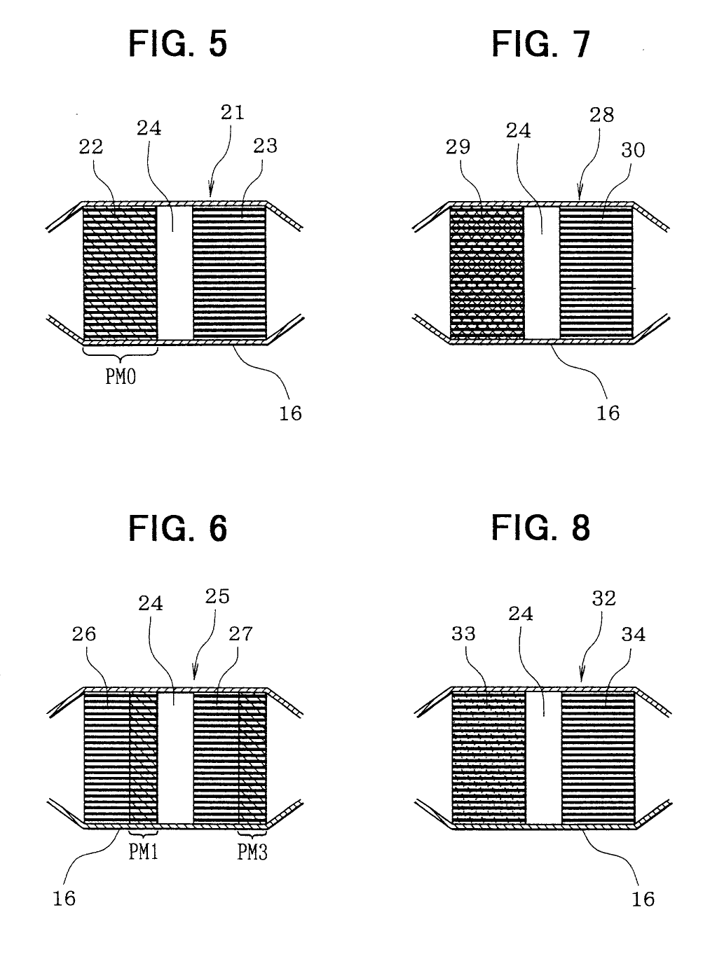

A second preferred embodiment of the present invention will be now described with reference to FIG. 5. In the above-described first embodiment, the amount of the precious metal carried on the downstream portion PM1 of the upstream catalyst block 17 and/or the upstream portion PM2 of the downstream catalyst block 18 is increased. In the second embodiment of the present invention, as illustrated in FIG. 5, the amount of a precious metal (irrespective of its kind) carried on the whole portion PM0 of an upstream catalyst block 22 of an upstream catalyst 21 is made greater than that of a downstream catalyst block 23. In the second embodiment, the other parts are similar to those of the above-described first embodiment.

Since exhaust pulsation is generated even on the upstream side of the upstream catalyst block 22 near the exhaust manifold 15, the amount of a precious metal carried on the whole portion PM0 of the upstream catalyst block 22 can be increased to increase the purification ratio of the exhaust gas by effectively using exhaust pulsation generated in the upstream side of the upstream catalyst block 22 and in a space portion 24 downstream thereof.

A third preferred embodiment of the present invention will be now described with reference to FIG. 6. In the third embodiment of the invention, as illustrated in FIG. 6, an amount of a precious metal (irrespective of its kind) carried on a downstream portion PM1 of an upstream catalyst block 26 and a downstream portion PM3 of a downstream catalyst block 27 among an upstream catalyst 25, is increased. When the capacity of the upstream catalyst 25 (i.e., the total capacity of the catalyst blocks 26, 27) is small, exhaust pulsation can be conveyed even to the downstream side of the downstream catalyst block 27. When the amount of the precious metal carried on the downstream portions PM1, PM3 of each of the catalyst blocks 26, 27 is increased, it is possible to improve the purification ratio of the exhaust gas by effectively using exhaust pulsation at the downstream portions PM1, PM3 of each catalyst block 26, 27. For example, when the amount of only Pd carried on each of the downstream portion PM1 of the upstream catalyst block 25 and the downstream portion PM2 of the downstream catalyst block 26 is increased, the exhaust gas can be purified efficiently, in an early stage after engine is started, owing to synergism of the early activation of the precious metal (Pd) and exhaust pulsation. In the third embodiment, the other parts are similar to those of the above-described first embodiment.

A fourth preferred embodiment of the present invention will be now described with reference to FIG. 7. According to test results by the inventors of the present invention, HC in an exhaust gas is adsorbed to Pd when the catalyst is still in an inactive state. In the fourth embodiment of the present invention, as illustrated in FIG. 7, only Pd is held as a precious metal on an upstream catalyst block 29 of an upstream catalyst 28.

According to the fourth embodiment, HC in the exhaust gas is adsorbed to the upstream catalyst block 29 (Pd) when the upstream catalyst block 29 (Pd) is inactive. The HC released from the upstream catalyst block 29 (Pd) after its activation is removed efficiently by the catalyst blocks 29, 30 by making effective use of the catalytic action of Pd and exhaust pulsation between the catalyst blocks 29, 30, whereby the exhausted amount of HC, which is generated at the starting time and has remained unburned, can be decreased effectively. In addition, because the precious metal (Pd) carried on the catalyst block 29 can be used also as an HC adsorbent, newly disposal of an HC adsorbent is not necessary. In the fourth embodiment, the other parts are similar to those of the above-described first embodiment.

A fifth preferred embodiment of the present invention will be now described with reference to FIG. 8. In the fifth embodiment of the present invention, as illustrated in FIG. 8, an all upstream catalyst block 33 of an upstream catalyst 32 is formed of an HC-adsorbing catalyst. The HC-adsorbing catalyst has a two-layer catalyst structure obtained by coating an inner wall surface of a ceramic carrier with an HC adsorbent such as zeolite and then coating the surface of the HC adsorbent with a precious metal, thereby having the precious metal held on the HC adsorbent.

When the catalyst of the upstream catalyst block 33 (HC adsorbing catalyst) is inactive, HC in an exhaust gas is adsorbed to the HC adsorbent. After activation of the catalyst, HC released from the HC adsorbent is efficiently removed at upstream and downstream catalyst blocks 33, 34 by making effective use of exhaust pulsation between the upstream and downstream catalyst blocks 33, 34.

Alternatively, in the fifth embodiment, the upstream catalyst block 33 is formed to carry thereon not a precious metal but only an HC adsorbent. In the fifth embodiment, the other parts are similar to those of the above-described first embodiment.

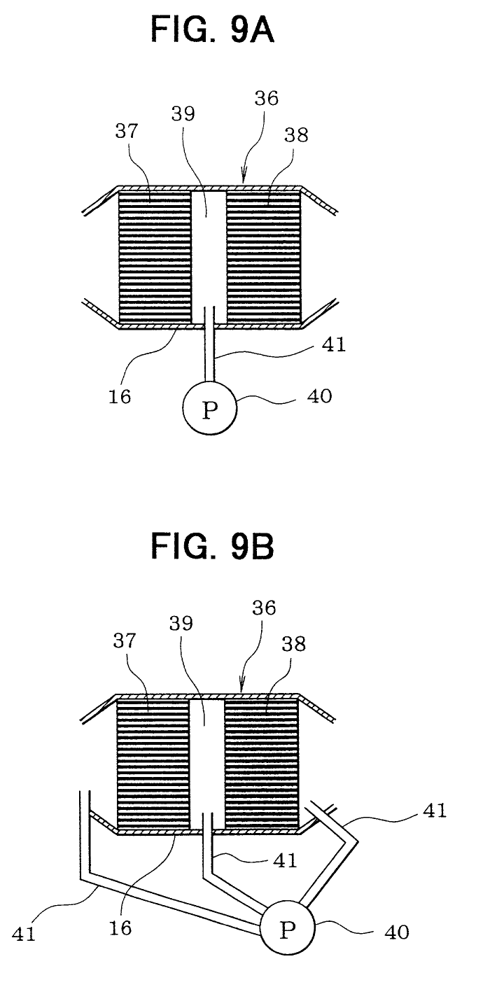

A sixth preferred embodiment of the present invention will be now described with reference to FIGS. 9A and 9B. In the sixth embodiment, as illustrated in FIG. 9A, a discharge pipe 41 of an air pump 40 (i.e., air introducing member), for introducing secondary air into a space portion 39 between upstream and downstream catalyst blocks 37, 38 of an upstream catalyst 36, is connected with the space portion 39. According to this structure, the secondary air introduced into the space portion 39 between the upstream and downstream catalyst blocks 37, 38 from the air pump 40 is stirred by exhaust pulsation, and the reaction between the components (HC, CO) rich in the exhaust gas with the oxygen of the secondary air is promoted, so that a high purification ratio of exhaust gas can be obtained.

As illustrated in FIG. 9B, the secondary air may be introduced from the air pump 40 into an upstream side of the upstream catalyst block 37 and the downstream side of the downstream catalyst block 38, as well as the space portion 39 between the upstream and downstream catalyst blocks 37, 38. In this case, exhaust pulsation occurring on the upstream side and downstream side of the catalyst blocks 37, 38 and introduction of secondary air make it possible to attain a still higher purification ratio of the exhaust gas.

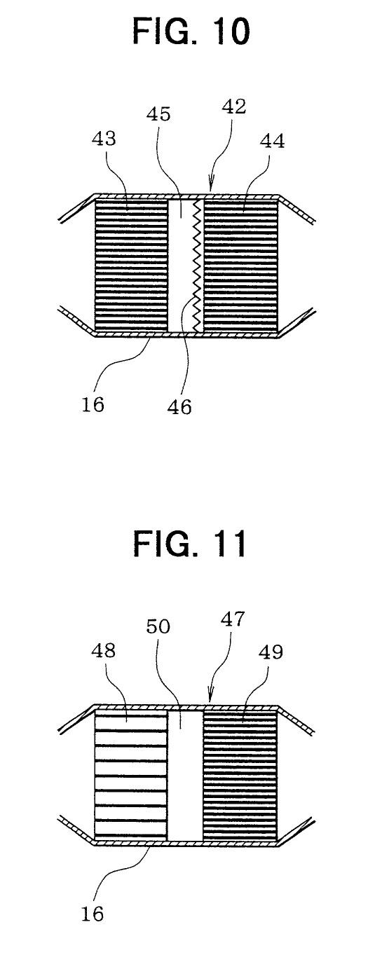

A seventh preferred embodiment of the present invention will be now described with reference to FIG. 10. In the seventh embodiment of the present invention, as illustrated in FIG. 10, an electric heater 46 is disposed in a space portion 45 between upstream and downstream catalyst blocks 43, 44 of an upstream catalyst 42 to heat a downstream portion of the upstream catalyst block 43 and an upstream portion of the downstream catalyst block 44. Accordingly, it possible to activate the downstream portion of the upstream catalyst block 43 and the upstream portion of the downstream catalyst block 44 in an early stage after engine is started. At the downstream portion of the upstream catalyst block 43 and the upstream portion of the downstream catalyst block 44, synergism of early activation by the heater 46 and exhaust pulsation heightens the purification ratio of exhaust gas in an early stage after starting, thereby largely improving exhaust emission at an engine starting time. In the seventh embodiment, the other parts are similar to those of the above-described first embodiment.

An eighth preferred embodiment of the present invention will be now described with reference to FIG. 11. In the eighth embodiment of the present invention, as illustrated in FIG. 11, an upstream catalyst block 48 of an upstream catalyst 47 is formed to have a smaller pressure loss than that of a downstream catalyst block 49. By widening the cross-sectional area of the passage of a cell (passage of an exhaust gas) of a ceramic carrier, the pressure resistance in the passage is reduced, and the pressure loss of the upstream catalyst block 48 can be decreased. A decrease in the pressure loss of the upstream catalyst block 48 makes it possible to form larger exhaust pulsation in a space portion 50 on the downstream side of the upstream catalyst block 48. As a result, purification-ratio improving effects brought by exhaust pulsation can be effectively obtained. In the eighth embodiment, the other parts are similar to those of the above-described first embodiment.

Although the present invention has been fully described in connection with the preferred embodiments thereof with reference to the accompanying drawings, it is to be noted that various changes and modifications will become apparent to those skilled in the art.

For example, in the above-described embodiments, a plurality of catalysts can be disposed in series in the passage of an exhaust gas. In this system, the most upstream catalyst is disposed at a position where exhaust pulsation occurs on the downstream side of the most upstream catalyst when catalyst early warming control is effected. On the other hand, in an exhaust gas system where only one catalyst is disposed in the passage of the exhaust gas, the catalyst is disposed at a position where exhaust pulsation occurs on the downstream side of the catalyst when catalyst early warming control is carried out. In both cases, it is possible to generate exhaust pulsation on the downstream side of the catalyst during catalyst early warming control, and therefore, it is possible to allow the catalyst to always exhibit its maximum purifying capacity by the effects of exhaust pulsation even when the catalyst is still inactive during catalyst early warming control. Since the exhaust pulsation occurring on the downstream side of the catalyst becomes smaller as the capacity of the catalyst (pressure loss) increases, the position of the catalyst is preferably set also in accordance with the capacity of the catalyst.

Such changes and modifications are to be understood as being within the scope of the present invention as defined by the appended claims.

What is claimed is:

1. An apparatus for purifying exhaust gas from an internal combustion engine, the apparatus comprising:
a case defining an exhaust passage through which exhaust gas flows;
a catalyst for purifying exhaust gas, the catalyst being divided into an upstream catalyst block disposed in the case at an upstream side, and a downstream catalyst block disposed in the case at a downstream side of the upstream catalyst block to form a space therebetween within the case; and
a precious metal which is carried in the upstream catalyst block and the downstream catalyst block in such a manner that an amount of the precious metal carried by at least one of a downstream portion of the upstream catalyst block and an upstream portion of the downstream catalyst block is made larger than that carried by the other part of the upstream catalyst block and the downstream catalyst block.

2. The apparatus according to claim 1, wherein:
the precious metal includes at least palladium (Pd) which is carried in the upstream catalyst block and the downstream catalyst block in such a manner that an amount of palladium carried by at least one of a downstream portion of the upstream catalyst block and an upstream portion of the downstream catalyst block is made larger than that carried by the other part of the upstream catalyst block and the downstream catalyst block.

3. The apparatus according to claim 1, further comprising
an another catalyst disposed at a downstream side of the downstream catalyst block,
wherein the another catalyst has a capacity larger than a total capacity of the upstream catalyst block and the downstream catalyst block.

4. The apparatus according to claim 1, wherein the precious metal carried in the upstream catalyst block is only palladium (Pd).

5. The apparatus according to claim 1, wherein the upstream catalyst block is formed of a HC-adsorbing catalyst for adsorbing hydrocarbon (HC) in exhaust gas.

6. The apparatus according to claim 1, further comprising
an air introduction member which introduces air into the space between the upstream catalyst block and the downstream catalyst block.

7. The apparatus according to claim 1, further comprising
a heater for heating, the heater being disposed in the space between the upstream catalyst block and the downstream catalyst block.

8. An apparatus for purifying exhaust gas from an internal combustion engine, the apparatus comprising:
a case defining an exhaust passage through which exhaust gas flows;
a catalyst for purifying exhaust gas, the catalyst being divided into an upstream catalyst block disposed in the case at an upstream side, and a downstream catalyst block disposed in the case at a downstream side of the upstream catalyst block to form a space therebetween within the case; and
a precious metal which is carried in the upstream catalyst block and the downstream catalyst block in such a manner that an amount of the precious metal carried by the upstream catalyst block is made larger than that carried by the downstream catalyst block.

9. An apparatus for purifying exhaust gas from an internal combustion engine, the apparatus comprising:
a case defining an exhaust passage through which exhaust gas flows;
a catalyst for purifying exhaust gas, the catalyst being divided into an upstream catalyst block disposed in the case at an upstream side, and a downstream catalyst block disposed in the case at a downstream side of the upstream catalyst block to form a space therebetween within the case; and
a precious metal which is carried in the upstream catalyst block and the downstream catalyst block in such a manner that an amount of the precious metal carried by at least one of a downstream portion of the upstream catalyst block and a downstream portion of a downstream catalyst block is made larger than that carried by the other part of the upstream catalyst block and the downstream catalyst block.

10. An apparatus for purifying exhaust gas from an internal combustion engine, the apparatus comprising:
a case defining an exhaust passage through which exhaust gas flows;
a catalyst for purifying exhaust gas, the catalyst being divided into an upstream catalyst block disposed in the case at an upstream side, and a downstream catalyst block disposed in the case at a downstream side of the upstream catalyst block to form a space therebetween within the case; and
a precious metal which is carried in the upstream catalyst block and the downstream catalyst block ,
wherein the precious metal carried by the upstream catalyst block is palladium.

11. An apparatus for purifying exhaust gas from an internal combustion engine, the apparatus comprising:
a case defining an exhaust passage through which exhaust gas flows; and
a catalyst for purifying exhaust gas, the catalyst being divided into an upstream catalyst block disposed in the case at an upstream side, and a downstream catalyst block disposed in the case at a downstream side of the upstream catalyst block to form a space therebetween within the case,
wherein the upstream catalyst block is formed of a HC-adsorbing catalyst for adsorbing hydrocarbon (HC) in exhaust gas.

12. An apparatus for purifying exhaust gas from an internal combustion engine, the apparatus comprising:
a case defining an exhaust passage through which exhaust gas flows;
a catalyst for purifying exhaust gas, the catalyst being divided into an upstream catalyst block disposed in the case at an upstream side, and a downstream catalyst block disposed in the case at a downstream side of the upstream catalyst block to form a space therebetween within the case; and
an air introduction member which introduces air into the space between the upstream catalyst block and the downstream catalyst block.

13. An apparatus for purifying exhaust gas from an internal combustion engine, the apparatus comprising:
a case defining an exhaust passage through which exhaust gas flows;
a catalyst for purifying exhaust gas, the catalyst being divided into an upstream catalyst block disposed in the case at an upstream side, and a downstream catalyst block disposed in the case at a downstream side of the upstream catalyst block to form a space therebetween within the case; and
a heater for heating, the heater being disposed in the space between the upstream catalyst block and the downstream catalyst block.

14. An apparatus for purifying exhaust gas from an internal combustion engine, the apparatus comprising:
a case defining an exhaust passage through which exhaust gas flows; and
a catalyst for purifying exhaust gas, the catalyst being divided into an upstream catalyst block disposed in the case at an upstream side, and a downstream catalyst block disposed in the case at a downstream side of the upstream catalyst block to form a space therebetween within the case,
wherein the upstream catalyst block has a pressure loss smaller than that of the downstream catalyst block.

15. An apparatus for purifying exhaust gas from an internal combustion engine, the apparatus comprising:
a case defining an exhaust passage through which exhaust gas from the engine flows;
a catalyst disposed in the case for purifying exhaust gas; and
control means for performing a catalyst early warming control in which the catalyst is early activated at a starting period of the engine,
wherein the catalyst is disposed in the case in such a manner that a downstream portion of the catalyst is set at a position where an exhaust pulsation is generated during the catalyst early warming control.

16. An apparatus for purifying exhaust gas from an internal combustion engine, the apparatus comprising:
a catalyst for purifying exhaust gas;
an exhaust pipe extending from the engine to an upstream end of the catalyst, through which exhaust gas from the engine is introduced into the catalyst, the exhaust pipe having a surface area;
control means for performing a catalyst early warming control in which the catalyst is early activated at a starting period of the engine,
wherein the catalyst is disposed at a predetermined position which is set based on heat quantity discharged from the engine during the catalyst early warming control, and the surface area of the exhaust pipe.

17. The apparatus according to claim 16, wherein:
the catalyst is divided into an upstream catalyst block disposed at an upstream side, and a downstream catalyst block disposed at a downstream side of the upstream catalyst block to form a space therebetween; and
a capacity of the upstream catalyst block is set based on at least one of an engine displacement, a heat quantity supplied to the upstream catalyst block and a flow amount of exhaust gas.

18. The apparatus according to claim 16, wherein:
the catalyst is divided into plural catalyst blocks disposed in an exhaust passage in series to have a most upstream catalyst block;
the most upstream catalyst block is disposed at a predetermined position which is set based on the heat quantity discharged from the engine during the catalyst early warming control, and the surface area of the exhaust pipe from the engine to an upstream end surface of the most upstream catalyst block; and
a capacity of the most upstream catalyst block is set based on at least one of an engine displacement, a heat quantity supplied to the most upstream catalyst block and a flow amount of exhaust gas.
